(19) United States
(12) Patent Application Publication
(10) Pub. No.: US 2020/0238316 A1
(43) Pub. Date: Jul. 30, 2020

(54) SPRAY GUN AND A CLEANING DEVICE HAVING THE SAME

(71) Applicant: SUZHOU CROSSTEC CO., LTD., Suzhou (CN)

(72) Inventor: Xiaobing ZHANG, Suzhou (CN)

(21) Appl. No.: 16/664,786

(22) Filed: Oct. 25, 2019

(30) Foreign Application Priority Data
Jan. 30, 2019 (CN) 201910089792.7

(51) Int. Cl. B05B 9/04; B05B 9/01; A47L 13/22

(52) U.S. Cl. CPC B05B 9/0403; A47L 13/22; B05B 9/01

(57) ABSTRACT

A spray gun includes a gun body, a motor and a water pump disposed in the gun body, and a power supply device; the motor is electrically connected to the power supply device; the water pump has its inlet in communication with the liquid inlet of the gun body, and its outlet in communication with the liquid outlet of the gun body; a liquid inlet check valve is arranged on the liquid inlet passage between the liquid inlet and the water pump, and a trigger mechanism is arranged on the gun body for controlling the opening of the liquid inlet check valve and the water pump. A cleaning device having the spray gun is also disclosed. The spray gun and the cleaning device can solve the liquid leakage problem.

This application claims the priority benefit of China Patent Application No. 201910089792.7 filed on Jan. 30, 2019, and entitled “A spray gun and a cleaning device having the same” which is incorporated by reference in its entirety.

### TECHNICAL FIELD

The present invention relates to the field of cleaning equipment, and in particular to a spray gun and a cleaning device having the same.

### BACKGROUND

In order to remove stains that are difficult to remove on floors and windowpanes, CN 108451437 A discloses a cleaning device with a spray function, which comprises a cleaning member, a nozzle assembly, a handle member and a spray assembly. The spray assembly comprises a spray gun and a liquid storage device. The spray gun, connected to the handle member, conveys the cleaning liquid to the cleaning liquid passage of the handle member, and is turned off after the cleaning liquid is delivered. The spray gun often has the problem of backflow of the cleaning liquid, and the nozzle assembly also has the problem of leakage.

### SUMMARY

In order to solve the problems of the prior art, an object of the present invention is to provide a spray gun and a cleaning device having the same, which have a simple structure and can prevent the problems of liquid backflow and leakage.

In view of the above problems, a technical solution provided by the present invention is as follows:

A spray gun is provided, comprising a gun body, a motor and a water pump disposed in the gun body, and a power supply device. The motor is electrically connected to the power supply device. The water pump has its inlet in communication with the liquid inlet of the gun body, and its outlet in communication with the liquid outlet of the gun body. A liquid inlet check valve is arranged on the liquid inlet passage between the liquid inlet and the water pump, and a trigger mechanism is arranged on the gun body for controlling the opening of the liquid inlet check valve and the water pump. For introduction of the liquid, the trigger mechanism is pulled to open the liquid inlet check valve. With the trigger mechanism continuing to be pulled, the trigger of the trigger mechanism contacts the micro switch connected to the power supply device to turn the water pump on. After the liquid introduction is completed, the trigger mechanism is released to reset, and the liquid inlet check valve is closed.

In some of these embodiments, the liquid inlet check valve comprises a first valve body, a first valve chamber disposed in the first valve body, a first spool disposed in the first valve chamber and extending at one end to the first spool outside the first valve body, and a first compression spring sleeved on the first spool; the first valve body is provided with a liquid inlet joint and a liquid outlet joint in communication with the first valve chamber; the first compression spring, located between a first limit portion of the first spool and the first valve body, makes the other end of the first spool sealingly engaged with the inner wall of the liquid outlet end of the first valve chamber; and the first spool is connected to the trigger mechanism.

In some of these embodiments, the first valve body comprises a housing with a cavity and an end cover disposed at one end of the housing; the first valve chamber is formed between the inner end of the end cover and the housing; the first spool passes through the end cover; the liquid inlet joint is disposed on the radial outer wall of the housing and communicates with the liquid inlet of the gun body, and the liquid outlet joint is disposed at the other end of the housing and communicates with the inlet of the water pump.

In some of these embodiments, the trigger mechanism comprises a trigger rotatably disposed on the gun body, and a liquid inlet check valve rod connecting the trigger and the first spool, with the trigger driving the first spool to move axially along the first valve body.

In some of these embodiments, the trigger comprises an operating portion disposed at the handle portion of the gun body, and a link portion connected to the liquid inlet check valve rod; a connecting portion of the operating portion and the link portion is rotatably disposed on the gun body; with the microswitch disposed between the operating portion and the gun body, there is a gap between the operating portion and the microswitch when the trigger mechanism is untriggered.

In some of these embodiments, the power supply device is a battery pack, and the gun body is provided at the bottom with a T-shaped slot, with the battery pack inserted in the T-shaped slot and electrically connected to a socket in the T-shaped slot.

In view of the above problems, another technical solution provided by the present invention is as follows:

A cleaning device is provided, comprising:

a cleaning member for cleaning;

a nozzle assembly connected to the cleaning member for spraying a cleaning liquid onto the surface to be cleaned;

a handle member having a lower end connected to the nozzle assembly, and provided inside with a cleaning liquid passage in communication with the nozzle assembly; and

a spray assembly for injecting a cleaning liquid into the cleaning liquid passage;

the spray assembly includes the spray gun described above.

In some of these embodiments, the spray assembly further includes a water storage device that comprises a backpack, and a water storage bag detachably disposed in the backpack and connected with the spray gun through a spring water pipe.

In some of these embodiments, the spring water pipe is connected to the water storage bag and the spray gun via a fast-connection joint, which comprises a male joint and a female joint matching with each other; the water outlet of the water storage bag and one end of the spring water pipe are respectively provided with the female joint, which is a fast-connection stop valve, and the liquid inlet of the spray gun and the other end of the spring water pipe are respectively provided with the male joint.

In some of these embodiments, the fast-connection stop valve comprises a second valve body, a second valve chamber disposed in the second valve body, and a second spool disposed in the second valve chamber; the second spool is arranged along the axial direction of the second valve body, with its inner end sidewall sealingly matched with a limit boss on the inner wall of the second valve chamber; the inner end of the second spool is provided with a seal retainer ring to limit the inner end of the second spool to the inner side of the limit boss; a second compression spring, sleeved on the second spool, has its inner end fixed on the limit boss and its outer end abutting against a second limit portion at the other end of the second spool; the second spool has an inlet flow passage arranged in the axial direction and closed at the inner end, and is provided on the outer wall with an opening in communication with the inlet flow passage; when the male joint is engaged with the female joint, the male joint drives the second spool to move toward the inner end to make the inlet flow passage in communication with the spring water pipe/water storage bag.

Compared with the prior art, the present invention has the following advantages:

1. With the technical solution of the present invention, a trigger mechanism and a liquid inlet check valve are arranged in the spray gun, with the liquid inlet check valve and the water pump successively controlled by the trigger mechanism. When the liquid introduction is completed, the trigger mechanism is released, and the liquid inlet check valve is closed, which can prevent the liquid backflow in the spray gun, and also solve the problem of nozzle leakage.

2. With the further technical solution of the present invention, a battery pack is used as the power supply device of the spray gun. For charging, only the battery pack needs to be disassembled and then charged, and it is not necessary to take the whole cleaning device or the spray gun to the charging place for charging, which makes the operation more convenient.

3. With the further technical solution of the present invention, a fast-connection stop valve is arranged on the spring water pipe and the water storage bag, respectively. On the one hand, this can quickly achieve the connection between the spring water pipe and the spray gun, the water storage bag; on the other hand, when the spring water pipe is removed from the spray gun and the water storage bag, neither the water storage bag nor the spring water pipe will leak.

### BRIEF DESCRIPTION OF DRAWINGS

In order to illustrate the technical solutions of the examples of the present invention more clearly, the drawings to be used in the description of the examples will be briefly described below. The drawings in the following description are only some examples of the present invention, and those skilled in the art can obtain other drawings based on these drawings without any creative work.

FIG. 1 is a schematic structural view of a cleaning device according to an example of the present invention;

FIG. 2 is a schematic structural view of a spray gun of the present invention;

FIG. 3 is a partial enlarged view of a position A in FIG. 2;

FIG. 4 is a sectional view along a line B-B in FIG. 2;

FIG. 5 is a schematic structural view of a water storage bag according to an example of the present invention;

FIG. 6 is a schematic structural view of a spring water pipe according to an example of the present invention; and

FIG. 7 is a partial enlarged view of a position C in FIG. 6.

### LIST OF REFERENCE NUMBERS

1. Cleaning member;

2. nozzle assembly;

3. handle member;

4. spray gun; 4-1. gun body; 4-2. motor; 4-3. water pump; 4-4. limit member; 4-5. T-shaped slot;

5. water storage bag; 5-1. water injection port; 5-2. water bag cover; 5-3. connecting belt;

6. spring water pipe; 6-1. connecting pipe; 6-2. spiral wire;

7. liquid inlet check valve; 7-1. first valve body; 7-1a. housing; 7-1b. end cover; 7-1c. liquid outlet joint; 7-1d. liquid inlet joint; 7-2. first valve chamber; 7-3. first spool; 7-3a. first limit portion; 7-4. first compression spring;

8. trigger mechanism; 8-1. trigger; 8-1a. operating portion; 8-1b. link portion; 8-2. liquid inlet check valve rod;

9. female joint; 9-1. second valve body; 9-2. second valve chamber; 9-3. second spool; 9-3a. inlet flow passage; 9-3b. second limit portion; 9-4. second compression spring;

10. male joint;

11. microswitch;

12. battery pack;

13. seal retainer ring; and

14. seal ring.

### DETAILED DESCRIPTION OF PREFERRED EMBODIMENTS

The above solution will be further described below with reference to specific examples. It is to be understood that these examples are intended to illustrate the present invention without limiting the scope thereof. The implementation conditions employed in the examples can be further adjusted according to the conditions of the specific manufacturer, with the unspecified implementation conditions being usually those in the conventional experiment.

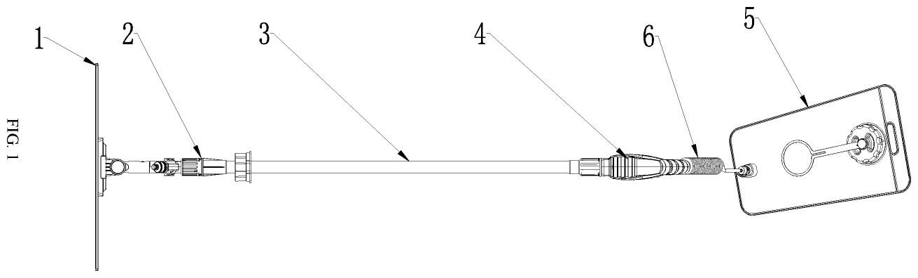

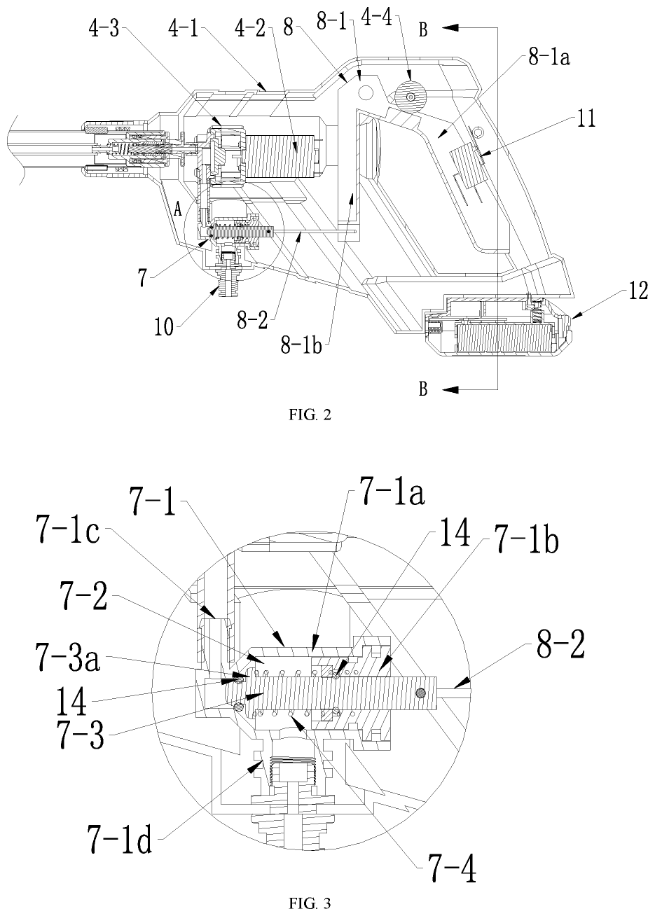

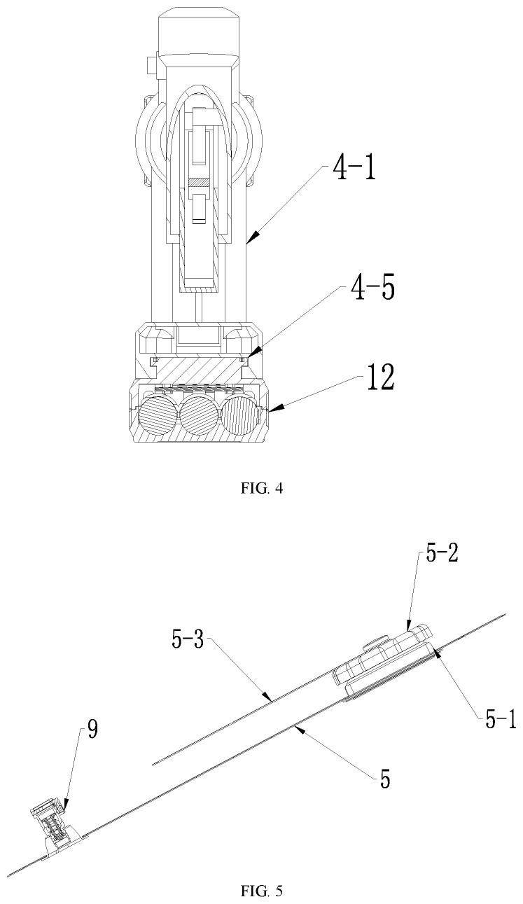

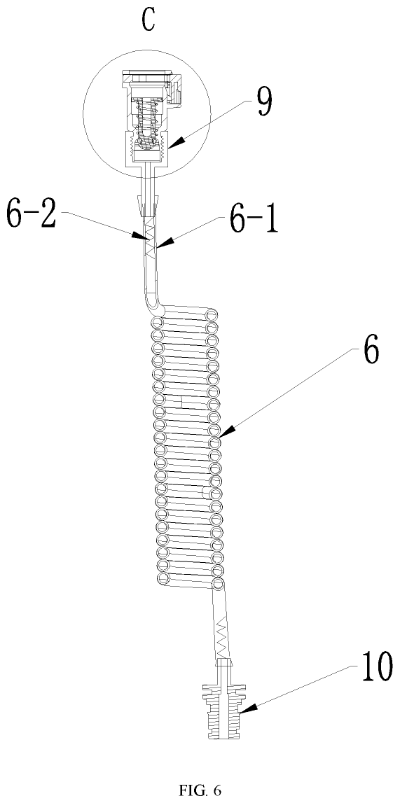

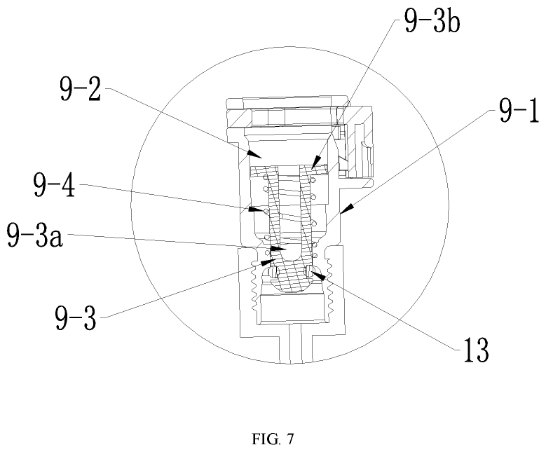

As shown in FIGS. 1-7 that are schematic structural views of an example of the present invention, a cleaning device is provided, comprising a cleaning member 1, a nozzle assembly 2, a handle member 3, and a spray assembly, wherein the cleaning member 1 can be a mop or a glass scraper. The nozzle assembly 2, connected to the cleaning member 1, is used for spraying a cleaning liquid onto the surface to be cleaned. The handle member 3, having its lower end connected to the nozzle assembly 2, is provided inside with a cleaning liquid passage in communication with the nozzle assembly 2. The spray assembly comprises a spray gun 4 and a water storage device connected thereto, with the spray gun 4 connected to the handle member 3 and injecting the cleaning liquid into the cleaning liquid passage.

In order to facilitate the operation of the cleaning device, the direction of the force applied to the handle portion of the spray gun 4 coincides with the direction in which the handle member 3 extends, so that it is convenient to drive the handle member 3 and the cleaning member 1 to move forward by pushing the spray gun 4, which avoids fatigue caused by prolonged use and improves the operational comfort.

The spray gun 4 comprises a gun body 4-1, a motor 4-2 and a water pump 4-3 disposed in the gun body 4-1, and a power supply device, with the motor 4-2 electrically connected to the power supply device. The water pump 4-3 has its inlet in communication with the liquid inlet of the gun body 4-1, and its outlet in communication with the liquid outlet of the gun body 4-1. In order to prevent backflow of the liquid in the spray gun 4, a liquid inlet check valve 7 is arranged on the liquid inlet passage between the liquid inlet and the water pump 4-3, and a trigger mechanism 8 is arranged on the gun body 4-1 for controlling the opening of the liquid inlet check valve 7 and the water pump 4-3. For introduction of the liquid, the trigger mechanism 8 is pulled to open the liquid inlet check valve 7. With the trigger mechanism 8 continuing to be pulled, the trigger 8-1 of the trigger mechanism 8 contacts a microswitch 11 connected to the power supply device to turn the water pump 4-3 on. The connection between the microswitch 11, the motor 4-2 and the power supply device is the prior art, and will not be described again in the present invention. After the liquid introduction is completed, the trigger mechanism 8 is released to reset, and the liquid inlet check valve 7 is closed, the trigger mechanism 8 cooperating with the liquid inlet check valve 7 to realize powering on after the water passes. When the liquid introduction is completed, the liquid inlet passage is closed by the liquid inlet check valve 7, which avoids backflow of the liquid in the spray gun 4 and also solves the problem of water leakage of the nozzle of the spray gun 4.

The liquid inlet check valve 7 comprises a first valve body 7-1, a first valve chamber 7-2 disposed in the first valve body 7-1, a first spool 7-3 disposed in the first valve chamber 7-2 and extending at one end to the first spool 7-3 outside the first valve body 7-1, and a first compression spring 7-4 sleeved on the first spool 7-3. The first valve body 7-1 is provided with a liquid inlet joint 7-1d and a liquid outlet joint 7-1c in communication with the first valve chamber 7-2. The first compression spring 7-4, located between the first spool 7-3 and the first valve body 7-1, makes the other end of the first spool 7-3 sealingly engaged with the inner wall of the liquid outlet end of the first valve chamber 7-2. With the first spool 7-3 connected to the trigger mechanism 8, the trigger mechanism 8 is used to control the movement of the first spool 7-3 within the first valve chamber 7-2, thereby opening or closing the liquid inlet passage.

Specifically, the first valve body 7-1 comprises a housing 7-1a with its axial direction in the horizontal direction and an end cover 7-1b disposed at one end of the housing 7-1a, a first valve chamber 7-2 being formed between the inner end of the end cover 7-1b and the housing; the first spool 7-3 passes through the end cover 7-1b; the first compression spring 7-4 is fixed at one end to the end cover 7-1b, and abuts at the other end against the first limit portion 7-3a of the first spool 7-3 near one end of the liquid outlet joint 7-1c; the first limit portion 7-3a is used to limit the first compression spring 7-4 on the one hand, and to limit the first spool 7-3 on the other hand to prevent the first spool 7-3 from slipping out of the first valve body 7-1; a seal ring 14 is provided between the first spool 7-1 and the end cover 7-1b, the liquid outlet joint 7-1c; the liquid inlet joint 7-1d is disposed on the radial outer wall of the housing 7-1a and communicates with the liquid inlet of the gun body 4-1, and the liquid outlet joint 7-1c is disposed at the other end of the housing 7-1a and communicates with the inlet of the water pump 4-3.

The trigger mechanism 8 comprises a trigger 8-1 rotatably disposed on the gun body 4-1, and a liquid inlet check valve rod 8-2 connecting the trigger 8-1 and the first spool 7-3, with the trigger 8-1 driving the first spool 7-3 to move axially along the housing 7-1a. When the trigger mechanism 8 pulls the first spool 7-3 away from the liquid outlet joint 7-1c, the spray gun 4 can be filled. When the trigger 8-1 is released, the first spool 7-3 is reset by the first compression spring 7-4, and the trigger mechanism 8 is reset.

The trigger 8-1 comprises an operating portion 8-1a disposed at the handle portion of the gun body 4-1, and a link portion 8-1b connected to the liquid inlet check valve rod 8-2. A connecting portion of the operating portion 8-1a and the link portion 8-1b is rotatably disposed on the gun body 4-1. With the microswitch 11 disposed between the operating portion 8-la and the gun body 4-1, there is a gap between the operating portion 8-1a and the microswitch 11 when the trigger 8-1 is untriggered.

In order to limit the trigger 8-1, a limit member 4-4 is further provided on the gun body 4-1 to control the rotation angle of the trigger 8-1.

In this example, in order to facilitate charging of the spray gun 4, a battery pack 12 is used as the power supply device, and the spray gun 4 is provided at the bottom with a T-shaped slot 4-5, with the battery pack 12 inserted in the T-shaped slot 4-5 and electrically connected to a socket in the T-shaped slot 4-5.

The spray assembly in this example further includes a water storage device that comprises a backpack, and a water storage bag 5 detachably disposed in the backpack and connected with the spray gun 4 through a spring water pipe 6. The backpack can be carried on the back for easy operation.

Specifically, the spring water pipe 6 is connected to the water storage bag 5 and the spray gun 4 via a fast-connection joint, which comprises a male joint 10 and a female joint 9 matching with each other; the water outlet of the water storage bag 5 and one end of the spring water pipe 6 are respectively provided with the female joint 9, which is a fast-connection stop valve, and the liquid inlet of the spray gun 4 and the other end of the spring water pipe 6 are respectively provided with the male joint 10; when the male joint 10 is connected to the female joint 9, the pipe is in communication; when the male joint 10 is separated from the female joint 9, the female joint 9 is closed to avoid water leakage.

The fast-connection stop valve comprises a second valve body 9-1, a second valve chamber 9-2 disposed in the second valve body 9-1, and a second spool 9-3 disposed in the second valve chamber 9-2. The second spool 9-3 is arranged along the axial direction of the second valve body 9-1, with its inner end sidewall sealingly matched with a limit boss on the inner wall of the second valve chamber 9-2. In this example, a seal retainer ring 13 is sleeved at the inner end of the second spool 9-3 for limiting the inner end of the second spool 9-3 to the inside of the limit boss. A second compression spring 9-4, sleeved on the second spool 9-3, has its inner end fixed on the limit boss and its outer end abutting against a second limit portion 9-3b at the other end of the second spool 9-3, with the second limit portion 9-3b used to limit the second compression spring 9-4. The second spool 9-3 has an inlet flow passage 9-3a arranged in the axial direction and closed at the inner end, and is provided on the outer wall with an opening in communication with the inlet flow passage 9-3a. When the male joint 10 is not connected to the female joint 9, the opening is located at the outer end of the second valve chamber 9-2, and the inlet flow passage 9-3a cannot communicate with the spring water pipe 6/water storage bag 5. When the male joint 10 is engaged with the female joint 9, the male joint 10 drives the second spool 9-3 to move toward the inner end, and the opening moves to the inner end of the second valve chamber 9-2, so that the inlet flow passage 9-3a is in communication with the spring water pipe 6/water storage bag 5 to make the cleaning liquid in the water storage bag 5 enter the spray gun 4. When the male joint 10 is separated from the female joint 9, the second spool 9-3 is reset by the second compression spring 9-4, the opening is moved to the outer end of the second valve chamber 9-2, and the inlet flow passage 9-3a cannot communicate with the spring water pipe 6/water storage bag 5, so that the water storage bag 5 and the spring water pipe 6 can be prevented from leaking.

In order to avoid bending of the spring water pipe 6 during use, a connecting pipe 6-1 is disposed between both ends of the spring water pipe 6 and the male joint 10/female joint 9, with the spiral wire 6-2 provided in the connecting pipe 6-1.

A water bag cover 5-2, provided at the water injection port 5-1 of the water storage bag 5, is screwed to the water injection port 5-1 and connected to the water injection port 5-1 via a connecting belt 5-3, so as not to get lost.

The above examples are only intended to illustrate the technical concept and the features of the present invention, so as to enable those skilled in the art to understand the present invention and implement it. The scope of protection of the present invention is not limited by the above examples. Any modification made according to the spiritual substance of the main technical solution of the present invention will all fall within the scope of protection of the present invention.

1. A spray gun, comprising:
a gun body,
a motor and a water pump disposed in the gun body,
and a power supply device,
the motor being electrically connected to the power supply device, the water pump having its inlet in communication with a liquid inlet of the gun body and its outlet in communication with a liquid outlet of the gun body,
wherein a liquid inlet check valve is arranged on the liquid inlet passage between the liquid inlet and the water pump, and a trigger mechanism is arranged on the gun body for controlling the opening of the liquid inlet check valve and the water pump; for introduction of the liquid, the trigger mechanism is pulled to open the liquid inlet check valve; with the trigger mechanism continuing to be pulled, the trigger of the trigger mechanism contacts a microswitch connected to the power supply device to turn the water pump on; after the liquid introduction is completed, the trigger mechanism is released to reset, and the liquid inlet check valve is closed.

2. The spray gun according to claim 1, wherein the liquid inlet check valve comprises a first valve body, a first valve chamber disposed in the first valve body, a first spool disposed in the first valve chamber and extending at one end to the first spool outside the first valve body, and a first compression spring sleeved on the first spool; the first valve body is provided with a liquid inlet joint and a liquid outlet joint in communication with the first valve chamber; the first compression spring, located between a first limit portion of the first spool and the first valve body, makes the other end of the first spool sealingly engaged with an inner wall of a liquid outlet end of the first valve chamber; and an outer end of the first spool is connected to the trigger mechanism.

3. The spray gun according to claim 2, wherein the first valve body comprises a housing with a cavity and an end cover disposed at one end of the housing; the first valve chamber is formed between an inner end of the end cover and the housing; the first spool passes through the end cover; the liquid inlet joint is disposed on a radial outer wall of the housing and communicates with the liquid inlet of the gun body, and the liquid outlet joint is disposed at the other end of the housing and communicates with the inlet of the water pump.

4. The spray gun according to claim 3, wherein the trigger mechanism comprises a trigger rotatably disposed on the gun body, and a liquid inlet check valve rod connecting the trigger and the first spool, with the trigger driving the first spool to move axially along the first valve body.

5. The spray gun according to claim 4, wherein the trigger comprises an operating portion disposed at a handle portion of the gun body, and a link portion connected to the liquid inlet check valve rod; a connecting portion of the operating portion and the link portion is rotatably disposed on the gun body; with the microswitch disposed between the operating portion and the gun body, there is a gap between the operating portion and the microswitch when the trigger mechanism is untriggered.

6. The spray gun according to claim 1, wherein the power supply device is a battery pack, and the gun body is provided at the bottom with a T-shaped slot, with the battery pack inserted in the T-shaped slot and electrically connected to a socket in the T-shaped slot.

7. A cleaning device, comprising:
a cleaning member for cleaning;
a nozzle assembly connected to the cleaning member for spraying a cleaning liquid onto the surface to be cleaned;
a handle member having a lower end connected to the nozzle assembly, and provided inside with a cleaning liquid passage in communication with the nozzle assembly; and
a spray assembly for injecting a cleaning liquid into the cleaning liquid passage;
wherein the spray assembly comprises the spray gun of claim 1.

8. The cleaning device according to claim 7, wherein the spray assembly further includes a water storage device that comprises a backpack, and a water storage bag detachably disposed in the backpack and connected with the spray gun through a spring water pipe.

9. The cleaning device according to claim 8, wherein the spring water pipe is connected to the water storage bag and the spray gun via a fast-connection joint, which comprises a male joint and a female joint matching with each other; the water outlet of the water storage bag and one end of the spring water pipe are respectively provided with the female joint, which is a fast-connection stop valve, and the liquid inlet of the spray gun and the other end of the spring water pipe are respectively provided with the male joint.

10. The cleaning device according to claim 9, wherein the fast-connection stop valve comprises a second valve body, a second valve chamber disposed in the second valve body, and a second spool disposed in the second valve chamber; the second spool is arranged along the axial direction of the second valve body, with its inner end sidewall sealingly matched with a limit boss on the inner wall of the second valve chamber; the inner end of the second spool is provided with a seal retainer ring to limit the inner end of the second spool to the inner side of the limit boss; a second compression spring, sleeved on the second spool, has its inner end fixed on the limit boss and its outer end abutting against a second limit portion at the other end of the second spool; the second spool has an inlet flow passage arranged in the axial direction and closed at the inner end, and is provided on the outer wall with an opening in communication with the inlet flow passage; when the male joint is engaged with the female joint, the male joint drives the second spool to move toward the inner end to make the inlet flow passage in communication with the spring water pipe/water storage bag.
